(19) United States
(12) Patent Application Publication
(10) Pub. No.: US 2026/0148081 A1
(43) Pub. Date: May 28, 2026

(54) IMPROVED LANGUAGE MODEL FOR GENERATING IMPROVED OUTPUTS

(71) Applicant: Intuit Inc., Mountain View, CA (US)

(72) Inventors: Shahram MOHREHKESH, Castro Valley, CA (US); Nan JIANG, Mountain View, CA (US); Grace WU, Redwood City, CA (US); Divya BEERAM, Mountain View, CA (US); Zachary DORSCH, Mountain View, CA (US)

(73) Assignee: Intuit Inc., Mountain View, CA (US)

(21) Appl. No.: 18/962,853

(22) Filed: Nov. 27, 2024

(51) Int. Cl. G06N 3/091

(52) U.S. Cl. CPC G06N 3/091

(57) ABSTRACT

A method of improving a language model and outputs of the language model. An output is received from a language model executed on an initial prompt. The output is validated by comparing the output to one or more rules. The output is determined to have failed to validate and in response, an updated prompt is generated. The updated prompt includes the output, at least one rule that caused the output to fail to validate, and an instruction to correct the output based on the at least one rule. The language model is executed on the updated prompt to generate a corrected output, which is validated by comparing the corrected output to the one or more rules. The language model is retrained on training data comprising at least the one or more rules, the output, the updated prompt, and the corrected output to yield a retrained language model.

### BACKGROUND

Language models, such as large language models (e.g., CHAT GPT®), are deep learning machine learning models (e.g., neural networks) trained to process natural language input and generate natural language output. For example, a language model may be the software engine that drives a chatbot.

Initial outputs from the language models may not provide the desired or targeted output, whether due to an inadequate initial prompt executed on by the language model or an inadequately trained language model. Further, such initial outputs may fail to validate when checked against a set of known regulations or rules regarding the desired or targeted output.

The above represents a technical problem with respect to language models. For example, an incorrect output may be addressed to the wrong user, or an inaccurate output may reference the wrong subject matter for a user. In another example, an inaccurate output may be written in language terms that are difficult for a user to understand when the user is unfamiliar with the subject matter of the output. Such inadequate outputs may also be detrimental to the owner of the language model, as the end users may develop a negative association with the product. For example, the end user may be offput by an output that uses the wrong name for the end user, causing the end user to develop the negative association with the owner of the language model. In another example, the recipient may lose trust in the owner or in the model if the output references the wrong subject matter.

Thus, a related technical problem exists. Namely, the related technical problem is how to develop a language model that can not only generate correct outputs but can also correct incorrect outputs and use the correct outputs to improve and fine tune the language model.

### SUMMARY

One or more embodiments provide for a method of improving a language model and outputs from the language model. The method includes receiving an output from a language model executed on an initial prompt. The method also includes validating the output by comparing the output to one or more rules. The method also includes determining that the output fails to validate based on the one or more rules. The method also includes generating, in response to the output failing to validate, an updated prompt. The updated prompt includes the output, at least one rule of the one or more rules that caused the output to fail to validate, and an instruction to correct the output based on the at least one rule. The method also includes executing, a second time, the language model on the updated prompt to generate a corrected output. The method also includes validating the corrected output by comparing the corrected output to the one or more rules. The method also includes determining that the corrected output is valid based on the one or more rules. The method also includes retraining the language model on training data to yield a retrained language model. The training data includes at least the one or more rules, the output, the updated prompt, and the corrected output.

One or more embodiments provide for a system of improving a language model and outputs from the language model. The system includes a computer processor and a data repository in communication with the computer processor. The data repository stores an output, an initial prompt, an updated prompt, one or more rules, an instruction, a corrected output, training data, and one or more constraints. The system also includes a language model which, when executed for a first time on the initial prompt, outputs the output. The language model also, when executed for a second time by the computer processor on the updated prompt, outputs the corrected output. The system also includes a retrained language model. The system also includes a training controller that, when executed by the computer processor, retrains the languages model on the training data to yield a retrained language model. The system also includes a server controller which, when executed by the computer processor, validates the output by comparing the output to the one or more rules. The server controller also, when executed by the computer processor, determines that the output fails to validate based on the one or more rules and generates, in response to the output failing to validate, an updated prompt. The server controller also, when executed by the computer processor, validates the corrected output by comparing the corrected output to the one or more rules.

One or more embodiments provide for a method of improving a language model and outputs from the language model. The method includes executing a language model on an initial prompt to generate an output. The initial prompt includes one or more constraints and an initial instruction to generate the output based on the one or more constraints. The method also includes retrieving one or more rules from an external knowledge base and validating the output by comparing the output to the one or more rules. The method also includes determining that the output fails to validate based on the one or more rules and generating, in response to the output failing to validate, an updated prompt. The updated prompt includes the output, at least one rule of the one or more rules that caused the output to fail to validate, and an instruction to correct the output based on the at least one rule. The method also includes executing, a second time, the language model on the updated prompt to generate a corrected output and validating the corrected output by comparing the corrected output to the one or more rules. The method also includes determining that the corrected output is valid based on the one or more rules and retraining the language model on training data to yield a retrained language model. The training data includes at least the one or more rules, the output, the updated prompt, and the corrected output. The method also includes presenting the corrected output for approval by one or more sources and determining that the corrected output is not approved by at least one source of the one or more sources. The method also includes modifying, in response to determining that the corrected output is not approve, the corrected output based on one or more instructions provided by the at least one source of the one or more sources. The method also includes retraining the retrained language model on updated training data to yield a fine-tuned language model. The updated training data includes the training data plus the corrected output.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for retraining a language model to yield an improved retrained language model, in accordance with one or more embodiments.

FIG. 3 shows a dataflow for retraining a language model to yield an improved retrained language model in accordance with one or more embodiments.

FIG. 4A shows an example of an output of a language model in accordance with one or more embodiments.

FIG. 4B shows an example of an improved output of an improved language model in accordance with one or more embodiments.

FIG. 5 shows a schematic diagram of an improved language model in accordance with one or more embodiments.

FIG. 6A and FIG. 6B show an example of a computing system and network environment, in accordance with one or more embodiments.

Like elements in the various figures are denoted by like reference numerals for consistency.

### DETAILED DESCRIPTION

One or more embodiments are directed to an improved language model. The improved language model solves at least the above-mentioned technical problem. The technical problem, again, is developing a language model that will correct incorrect outputs and use the correct outputs to improve and fine tune the language model to eventually more frequently generate correct outputs after an initial query. One or more embodiments solve the technical problem by the following procedure.

Initially, one or more embodiments generate an output (e.g., content such as text and/or images) by a language model using an initial prompt. The initial prompt includes constraints for the output, contextual information regarding a context of the output, and instructions to generate the output based on the constraints and the contextual information. The constraints can include specifications for the output such as a length, tone, voice, style, and/or type of output (e.g., text, images, videos, or any combination thereof). The contextual information can include information about the customer and/or a relationship between the customer and a product described in the output. For example, the contextual information can give information such as the customer is a new user to the product or that the customer is an existing user of the product.

The output is validated against rules regarding a length, content, voice, tone, and/or style of the output. The rules can be obtained from an external database using a retrieval augment generation (RAG) model. When the output is not validated (e.g., does not satisfy at least one rule of the one or more rules), the output and the at least one rule are used as input for an updated prompt.

The updated prompt is then provided as input to the language model and instructs the language model to generate the corrected output. The corrected output is generated by either modifying the output to conform to the at least one rule or using the output as an example in conjunction with the at least one rule. The corrected output is then validated against the rules to confirm that the corrected output has been sufficiently modified. The corrected output is then used as training data to fine tune the language model and generate an improved and retrained language model. The process may be repeated to further fine tune and improve the language model.

Thus, one or more embodiments provide for an improved language model that can self-correct invalid outputs and use the corrected outputs to retrain and improve the language model. The improved language model may have a higher rate of success of generating an output that is valid without additional modification, relative to the initial language model.

As a specific example, a content generator for a product may submit a request to generate content such as a targeted ad to a set of users. An initial prompt describing the user and the product may be generated and provided as input to a language model. The language model may generate the requested content as an output.

The output may be validated by comparing the output to a set of known rules and/or regulations. The rules may include, for example, a set length for the output, a desired voice or style, or specific product descriptions that should be included in the output. When the output is not validated and does not satisfy at least one rule, an updated prompt is generated. For example, the output may include product information for an experienced user when the rule is that the user is a new user. Thus, the output as directed to the experienced user does not satisfy the rule that the output should be directed to the new user. The updated prompt includes the output, the rule, and instructions to modify the output or use the output as an example in conjunction with the rule to generate a corrected output.

The language model is executed on the updated prompt to generate the corrected output. The corrected output is then compared to the rules to ensure that the corrected output has been sufficiently modified. For example, the corrected output may include information about the product for a new user instead of an experienced user. When the corrected output is determined to be valid, the corrected output is used as part of training data to retrain and improve the language model. The retrained language model can then be used to generate new outputs (and new corrected outputs if the new outputs fail to validate).

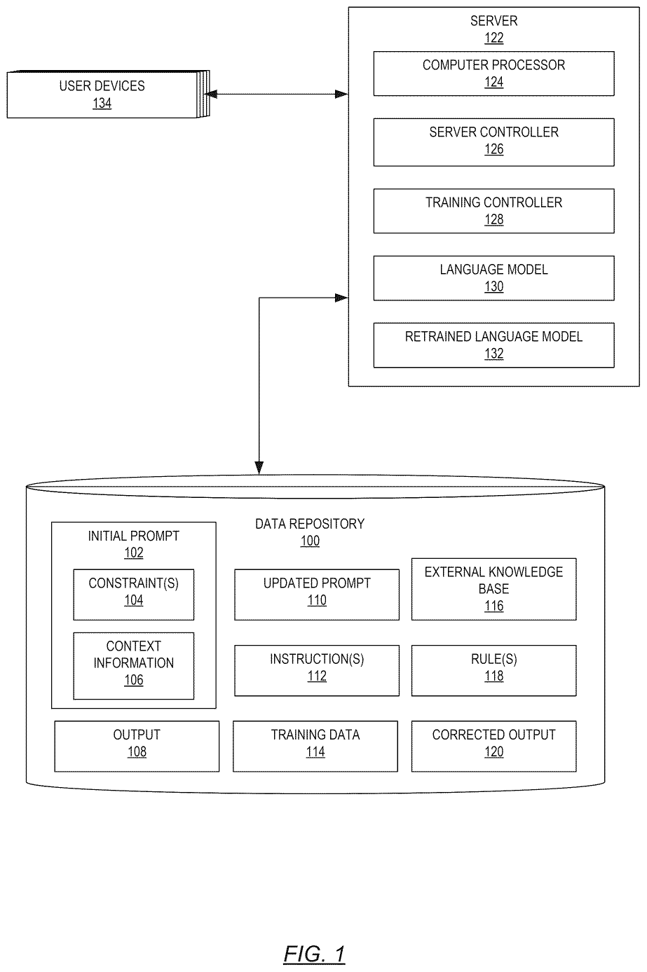

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores an initial prompt (102). The initial prompt (102) is a set of data that can be interpreted and understood by a language model (130) (described below) and describes a desired output of the language model (130). The initial prompt (102) can include, for example, natural language text and/or media to describe the desired output. More specifically, the initial prompt (102) includes constraints (104) for an output (108), contextual information (106) regarding a context of the output (108), and an initial instruction to generate the output (108) based on the constraints (104) and the contextual information (106). Additionally, the initial prompt (102) also may include example(s) of the desired output for the language model (130).

The data repository (100) also stores the constraints (104). The constraints (104) are provided in the initial prompt (102) and describe one or more limitations on the output (108). Examples of the constraints (104) for a text-based output are “write the output at a 5^{th} to 8^{th}-grade reading level”; “title should be a maximum of 90 characters”; “body message should be a maximum of 149 characters”; etc. The constraints (104) may be constructed in natural language text, which is then converted to a machine-readable format that can be read by the language model (130).

The data repository (100) also stores the contextual information (106). The contextual information (106) is information provided in the initial prompt (102) that describes the target audience of the output (108), a product that is to be recommended to the target audience in the output (108), and/or a correlation between the target audience and the product. Examples of the contextual information (106) are “customers have just started their business” (description of target audience); “assisted service is an add-on monthly subscription that provides the customer with a team of experts who can offer guidance and coaching” (description of the product); “customers are uncertain and are trying to understand how to get the product set up; and an expert can help the customers feel more confident by answering their questions” (correlation between the target audience and the product).

The data repository (100) also stores an output (108). The output (108) is generated by a language model (130) using the initial prompt (102). The output (108) is one or more documents that contain natural language text and/or media. Media includes images and/or video that can be embedded or otherwise inserted into the one or more documents.

The data repository (100) also stores one or more rules (118). The one or more rules (118) are regulations or principals stored in an external knowledge base (116). The rules (118) may include one or more deterministic rules or one or more non-deterministic rules. An example of a deterministic rule is “text should not exceed more than 150 words.” An example of a non-deterministic rule is “content should have an uplifting tone.” The rules (118) are used to validate the output (108) by comparing the output (108) to the rules (118). For example, the at least one rule may be “leverage inputs provided in an initial prompt without using them verbatim” and the output (108) may be evaluated to determine if the output (108) has used inputs provided in the initial prompt (102) verbatim. Another example of a rule is “text should not exceed more than 150 words” and the output (108) may be evaluated to determine if the output (108) has more than 150 words.

The data repository (100) also stores an updated prompt (110). The updated prompt (110) is similar to the initial prompt (102) in that the updated prompt (110) includes a set of data that can be interpreted and understood by the language model (130) to describe a desired output of the language model (130). The updated prompt (110) also differs from the initial prompt (102) in that the updated prompt (110) aims to improve the output (108) (generated by the language model (130) using the initial prompt (102)). More specifically, the updated prompt (110) includes at least the output (108), at least one rule of the rules (118) that the output (108) did not satisfy, and instructions to generate a corrected output (120). In some instances, the instructions to generate the corrected output (120) include instructions to modify the output (108) itself. In other instances, the instructions to generate the corrected output (120) include instructions to use the output (108) as an example along with the rule to generate a new output.

The data repository (100) also stores instructions (112). The instructions (112) are directions describing how the language model (130) generates the desired output. For example, the instructions (112) to generate the output (108) may include instructions (112) to generate content with natural language having a title and a body of text. In another example, the instructions (112) to generate the corrected output (120) includes instructions (112) to modify the output (108) such that the corrected output (120) satisfies the at least one rule included in the updated prompt (110). For example, the at least one rule may be “leverage the inputs provided in the initial prompt without using them verbatim” and the instructions (112) may be to modify the output (108) such that the corrected output (120) does not repeat verbatim the inputs provided in the initial prompt.

The data repository (100) also stores a corrected output (120). The corrected output (120) is the output (108) after the language model (130) has modified the output (108) based on the updated prompt (110). The corrected output (120), like the output (108), can include text, images, and/or video. The corrected output (120) can then be used to retrain the language model (130), thereby improving the language model (130) by providing new training data having the corrected output (120).

The data repository (100) also stores training data (114). The training data (114) is a set of information which is used to train machine learning models. The training data (114) may include example outputs, the corrected output (120), the output (108), the language model (130) (defined below), and/or a retrained language model (132) (also defined below). The training data (114) may be labelled to identify correct outputs or incorrect outputs. The training data (114) may also be labelled to identify different types of tones, voice, or other non-deterministic features of the training data (114). For example, text such as “Missed your appointment or need to meet with your bookkeeper again?” is labelled as “warm” and text such as “Fine-tune the product to see where your money is going” is labelled as “confident”.

The data repository (100) also stores an external knowledge base (116). The external knowledge base (116) is external to and separate from the language model (130). The external knowledge base (116) is similar to the data repository (100) in that the external knowledge base (116) is a type of storage unit or device (e.g., a file system, database, data structure, or any other storage mechanism) for storing data. The external knowledge base (116) stores the one or more rules (118). In some embodiments, the one or more rules (118) are converted to and stored as one or more corresponding vectors.

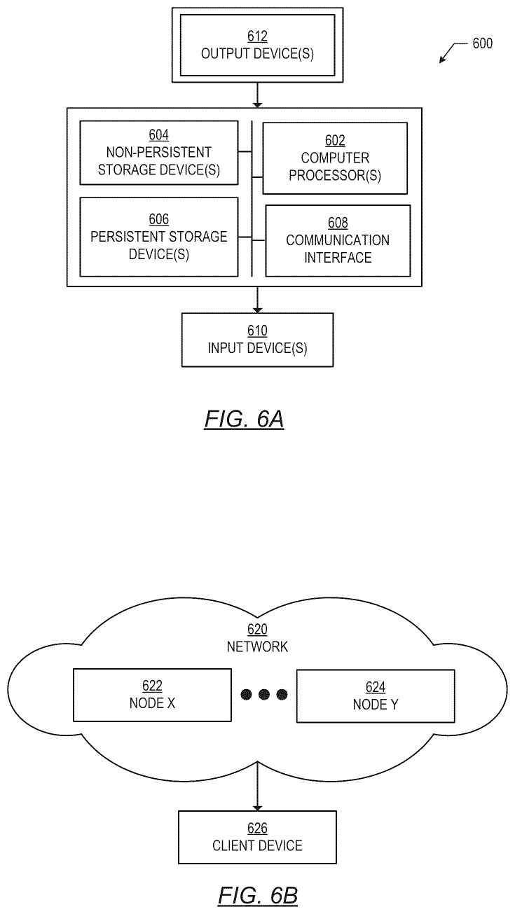

The system shown in FIG. 1 may include other components. For example, the system shown in FIG. 1 also may include a server (122). The server (122) is one or more computer processors, data repositories, communication devices, and supporting hardware and software. The server (122) may be in a distributed computing environment. The server (122) is configured to execute one or more applications, such as the language model (130), the retrained language model (132), or the training controller (128). An example of a computer system and network that may form the server (122) is described with respect to FIG. 6A and FIG. 6B.

The server (122) includes a computer processor (124). The computer processor (124) is one or more hardware or virtual processors which may execute computer readable program code that defines one or more applications, such as the language model (130), the retrained language model (132), or the training controller (128). An example of the computer processor (124) is described with respect to the computer processor(s) (602) of FIG. 6A.

The server (122) also may include a server controller (126). The server controller (126) is software or application specific hardware which, when executed by the computer processor (120), controls and coordinates operation of the software or application specific hardware described herein. Thus, the server controller (126) may control and coordinate execution of the training controller (128), the language models (130), the retrained language models (132).

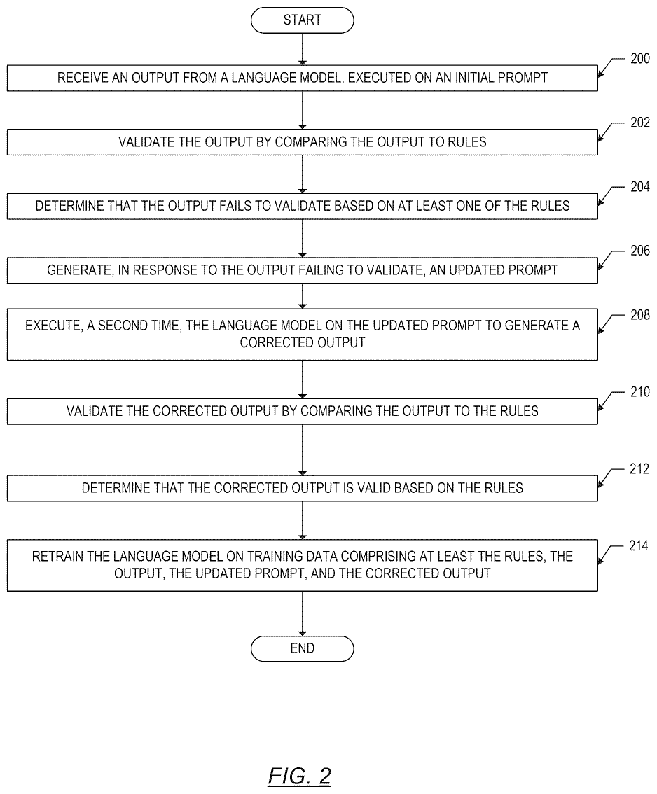

The server controller (126) also may be programmed to perform specific steps with respect to FIG. 2. For example, the server controller (126) may validate an output (108), determine that the output (108) fails to validate, generate an update prompt (110), and determine whether a corrected output (120) is validated, as explained further with respect to FIG. 2.

The server (122) also may include a training controller (128). The training controller (128) is software or application specific hardware which, when executed by the computer processor (124), trains one or more machine learning models (e.g., the language model (130)).

The server (122) also includes the language model (130). The language model (130) is a natural language processing machine learning model. An example of the language model (130) may be a large language model, such as CHATGPT® or LLAMA®. However, many different language models may be used. Use of the language model (130) is described with respect to FIG. 2.

The server (122) also includes a retrained language model (132). The retrained language model (132) is the language model (130) after being trained using at least the correct output (108) as the training data (114). The retrained language model (132) is improved, relative to the language model (130), and is more capable of generating an output (108) that will successfully validate against the one or more rules (118).

The system shown in FIG. 1 also may include one or more user devices (134). The user devices (134) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

In any case, the user devices (134) are computing systems (e.g., the computing system (600) shown in FIG. 6A) that communicate with the server (122). A request to generate an output (108) may be received via the user devices (134), or an automated process. In another embodiment, one or more of the user devices (134) may be operated by a computer technician that services the various components of the system shown in FIG. 1.

In contrast, a local user device is a device operated under the control of the organization that controls the other components of the system of FIG. 1. Thus, a local user device may be considered part of the system of FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for generating an improved language model, in accordance with one or more embodiments. The method of FIG. 2 may be implemented using the system of FIG. 1 and one or more of the steps may be performed on or received at one or more computer processors. The method of FIG. 2 may be characterized as a method of improving a language model to generate correct outputs.

Step 200 includes receiving an output from a language model executed on an initial prompt. The output is received from the language model by a server controller. The output includes text, images, and/or videos. To generate the output, the language model is executed, for a first time, on the initial prompt to generate the output. Executing the language model on the initial prompt may be performed by providing the initial prompt as input to the language model and then commanding the language model to execute. The initial prompt includes one or more constraints, contextual information regarding a context of the output, and an initial instruction to generate the output based on the one or more constraints and the contextual information.

Step 202 includes validating the output by comparing the output to a number of rules. More specifically, the server controller compares the output to the rules. The rules may be retrieved from a knowledge repository external to the language model. The rules may be retrieved by executing a retrieval-augmented generation (RAG) model (using, for example, the server controller) to retrieve the one or more rules based on the contextual information in the initial prompt.

The knowledge repository is generated by converting the rules into vectors. Thus, when the RAG model receives an input to retrieve the rules, the input is converted into an input vector and is used to identify at least one corresponding vector of the rules that matches the input vector. The vector(s) are then retrieved by the RAG model and converted into the corresponding rule(s).

Step 204 includes determining that the output fails to validate based on at least one of the rules. The output is determined to have failed by the server controller. More specifically, the output is determined to have failed to validate when the output does not satisfy at least one of the rules. In other words, the output is compared to each rule and if the output does not satisfy or breaks at least one of the rules, then the output is determined to have failed to validate. In some embodiments, the output can break multiple rules. In at least one example of the output failing to validate, one of the rules may be “do not exceed 150 characters” and the output may have 160 characters. In another example, one of the rules may be “use a friendly tone” and the output may be determined to have an unfriendly tone or may be determined to have used a tone determined not to be “friendly” for whatever reason.

Note that the term “friendly” would be a non-deterministic rule, as defined with respect to FIG. 1. Again, a non-deterministic rule is determined to be satisfied, or not satisfied, by a language model or some other machine learning model.

Step 206 includes generating, in response to the output failing to validate, an updated prompt. Upon determining that the output fails to validate in the step 204, the server controller generates the updated prompt. The updated prompt includes the output, at least one rule that caused the output to fail to validate, and an instruction to correct the output based on the at least one rule. As previously described, in some instances, the instructions to generate the corrected output include instructions to modify the output itself. In other instances, the instructions to generate the corrected output include instructions to use the output as an example to generate a new output.

Step 208 includes executing, a second time, the language model on the updated prompt to generate a corrected output. The language model is executed for the second time after the server controller generates the updated prompt in the step 206. Executing the language model on the updated prompt may be performed by providing the updated prompt as input to the language model and then commanding the language model to execute. As described above, the corrected output is the output as modified to satisfy the rule that the output did not initially satisfy. In other embodiments, the corrected output may be a newly generated output formed from the language model using the output as a template.

While step 208 contemplates executing the language model a second time, one or more embodiments contemplates using a different language model to generate the corrected output. Thus, one or more embodiments contemplate a model ensemble where an evaluator model (i.e., the different language model) evaluates the output of the large language model that generated the output.

Step 210 includes validating the corrected output by comparing the corrected output to the rules. Similar to the step 202 described above, the server controller compares the corrected output to the rules. The rules are the same rules used to validate the output. Thus, the corrected output is compared to the same rules as the output to determine if the corrected output now satisfies all of the rules.

Step 212 includes determining that the corrected output is valid based on the rules. The corrected output is determined to be valid by the server controller. More specifically, the corrected output is determined to be valid when the corrected output satisfies all of the rules.

In some embodiments, the corrected output may be presented for approval by one or more sources. The corrected output may be modified when the corrected output is not approved by at least one of the sources. The sources may be various authorities such as another automated process (e.g., automated software that rejects the corrected output as being incorrect or incorrectly formatted). The sources also may include one or more users, such as a user at a legal department, a human resources department, and/or a marketing department.

The corrected output may be modified based on instructions provided by the at least one source of the one or more sources. For example, an automated process may modify the corrected output to specify the corrected output should be modified in format or language in order to comply with the requirements of the automated process. In another example, the legal department may modify the corrected output to satisfy a legal requirement. In any example, the modified corrected output may then be validated, according to the procedure described above, to confirm that the modified corrected output still satisfies the rules.

After the corrected output or the modified corrected output is determined to be valid or otherwise in a final form, the corrected output or the modified corrected output may be presented. Presenting the output may include routing the output to another automated process, as described above. Presenting the output also may include routing the output to an end user. Presenting the corrected output or the modified corrected output can also include storing the corrected output or the modified corrected output in, for example, a data repository.

Step 214 includes retraining the language model on training data to yield a retrained language model. Retraining the language model includes executing the training controller on the language model to retrain the language model. The training data includes at least the rules, the output, the updated prompt, the corrected output, and/or the language model.

In general, retraining the language model involves iteratively testing the language model against test data for which the final result is known, comparing the test results against the known result, and using the comparison to adjust the model. The process is repeated until the results of the model do not improve more than some pre-determined amount, or until some other termination condition occurs. Satisfaction of the termination condition is known as convergence. After training or retraining, the retrained language model is applied to unknown data (i.e., data for which the actual result is not known) in order to generate outputs.

The above-described training is known as the training phase of machine learning. Use of the trained or retrained model is known as an inference stage of machine learning.

In some embodiments, the method (or any combination of steps) can be repeated one or more times. For example, in a second execution of the method, the correct output can be used as the output in the steps 200, 202, and 204 and a second correct output can be generated. Further, the method can be completed with fewer steps. For example, the method may end at the step 202 if the output is valid.

While the various steps in this flowchart are presented and described sequentially, at least some of the steps may be executed in different orders, may be combined or omitted, and at least some of the steps may be executed in parallel. Furthermore, the steps may be performed actively or passively.

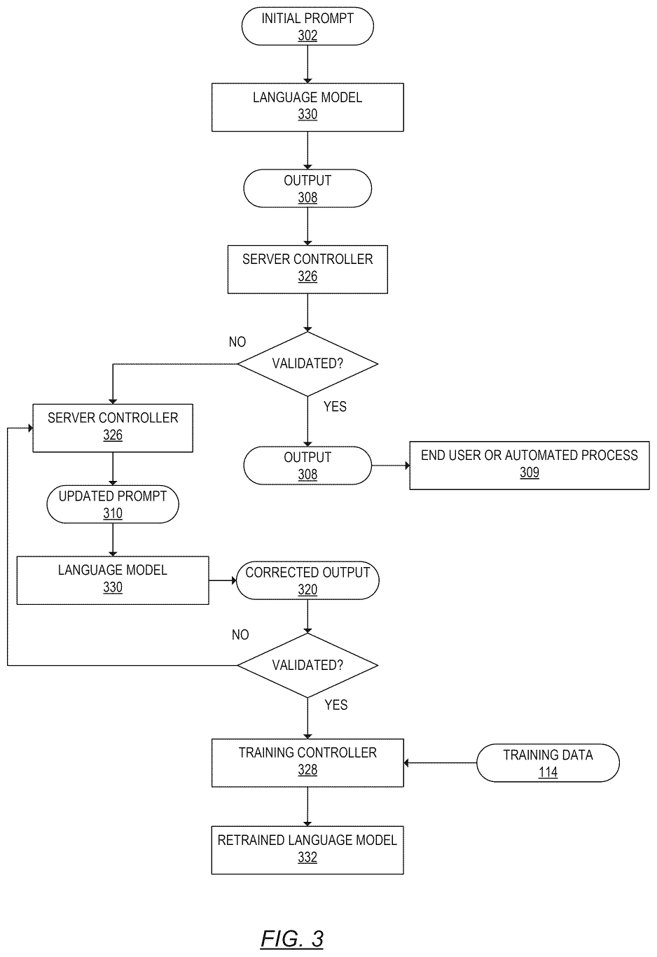

FIG. 3 shows a dataflow for a method for generating an improved language model, in accordance with one or more embodiments. The dataflow of FIG. 3 may be implemented using the system of FIG. 1 and one or more of the steps may be performed on or received at one or more computer processors. The dataflow of FIG. 3 is a variation of the method of FIG. 2.

An initial prompt (302) is available to a language model (330). The language model (330) is executed on the initial prompt (302) to generate an output (308). The output (308) is then validated by a server controller (326). The server controller (326) validates the output (308) by comparing the output (308) to rules. The rules may be retrieved from an external knowledge base by a RAG model.

If the output (308) is validated, then the output (308) is presented to an automated process an end user (309). If the output (308) is not valid because the output (308) does not satisfy at least one rule, then the server controller (326) generates an updated prompt (310).

The updated prompt (310) includes the output (308), the at least one rule, and instructions to generate a corrected output (320) based on the output (308), and the at least one rule. In some instances, the instructions to generate the corrected output (320) include instructions to modify the output (308) itself. In other instances, the instructions to generate the corrected output (320) include instructions to use the output (308) as an example alongside with the at least one rule to generate a new output. The instructions also may include instructions to generate a new rule, and then add the new rule to the existing rules (e.g., the at least one rule mentioned above).

After the updated prompt (310) is generated, the updated prompt (310) is provided as input to the language model (330). The language model (330) is executed on the updated prompt (310) and generates a corrected output (320). The corrected output (320) is then validated by the server controller (326). Similarly to the output (308), the server controller (326) validates the corrected output (320) by comparing the corrected output (320) to the rules.

If the corrected output (320) is not validated because the corrected output (320) does not satisfy at least one rule, the server controller (326) generates another updated prompt (310). The updated prompt (310) in this instance includes the corrected output (320), the at least one rule, and instructions to generate another corrected output (320) based on the at least one rule. The described loop when the corrected output (320) is not validated may be repeated until the corrected output (320) is validated, or until a stop condition is achieved (e.g., after a threshold number of failed validations is achieved). If a stop condition is achieved, then the dataflow of FIG. 3 may end prematurely and an error condition may be returned to an automated process or to a user that initiated the dataflow of FIG. 3.

If the corrected output (320) is validated, then a training controller (328) may be executed on the language model (330) and training data (114) to generate a retrained language model (332). The training data (114) includes at least the corrected output (320) (once validated). Training may be performed as described with respect to step 214 of FIG. 2.

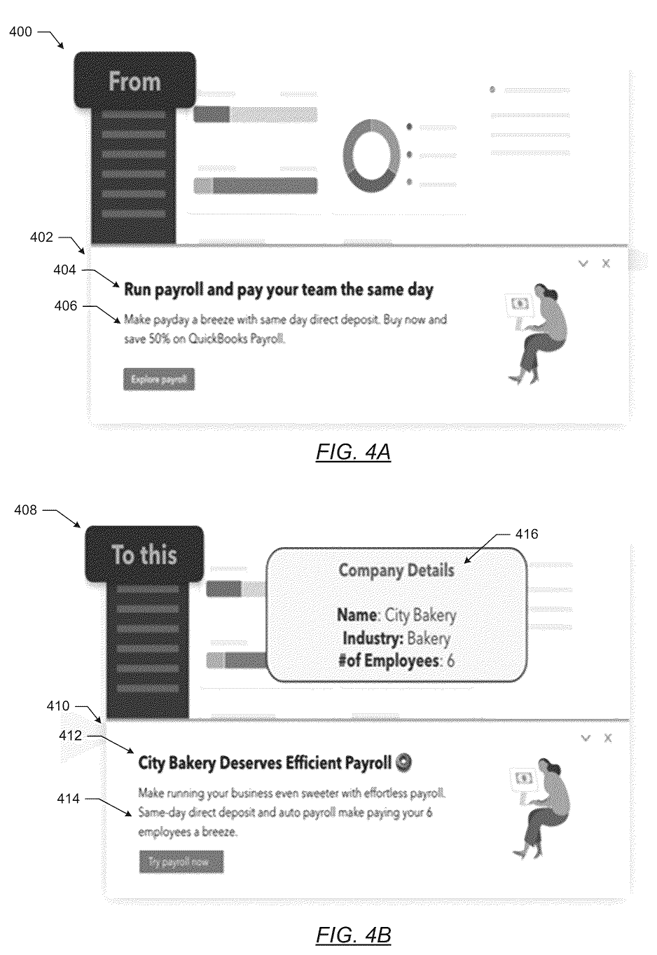

FIGS. 4A and 4B shows an example of an output from a language model and an improved output generated from an improved language model, respectively, in accordance with one or more embodiments. The following example is for explanatory purposes only and not intended to limit the scope of one or more embodiments.

As shown in FIG. 4A, an output (400) includes a text output (402) having a customer introduction (404) and a product description (406). However, the text output (402) as shown is generic and not personalized to an end user. Thus, when the output (400) is validated and compared against one or more rules, as previously described in FIGS. 2 and 3, the output (400) is determined to not be valid. For example, the one or more rules may include “the customer introduction must include the customer's name”. As shown in FIG. 4A, the example customer introduction (404) does not include any customer information or customer name and thus, the output (400) is not valid.

FIG. 4B shows an example of a corrected output (408). The corrected output (408) may be generated by a language model using an updated prompt, as described in FIGS. 2 and 3. As shown, the corrected output (408) includes the text output (440) as modified to include a corrected customer introduction (412) and a corrected product description (414) that is based on customer information (416). In the illustrated embodiment, the customer information (416) is shown for reference and the corrected output (408) does not display the customer information (416). As shown, the corrected customer introduction (412) now addresses the customer by the company name (e.g., City Bakery) and is tailored to the company as a bakery with the use of a donut emoji. Similarly, the corrected product description (414) incorporates the customer information (416) to include that the product can be used with respect to the 6 employees of the bakery. Such personalization may encourage a customer to purchase for the described service.

The corrected output (408) may then be used as training data for training the language model that generated the output (400). The retrained language model may then be used to generate a new output that may have a higher chance of successful validation than the output (400) generated by the initial language model. Thus, the retrained language model is an improved language model as compared to the initial language model.

Further, as the customer information (416) changes, so does the output (400) and corrected output (408). In other words, each output (400) and corrected output (408) is generated and personalized for each set of customer information (416). For example, a first set of customer information (416) will have a different output (400) than a second set of customer information (416). Thus, a large number of outputs can be individually generated for a corresponding large number of customers.

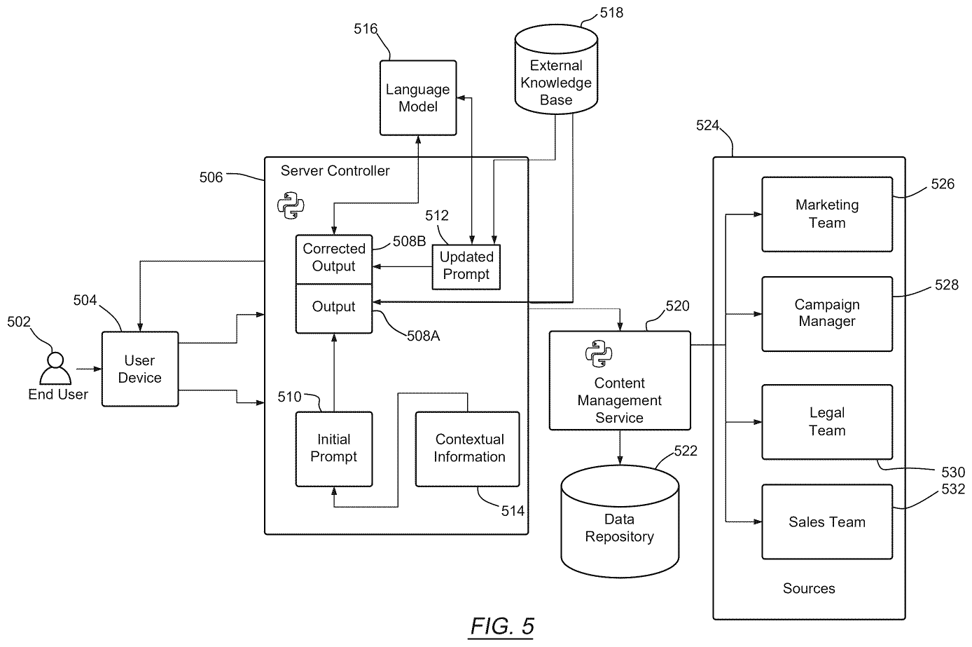

FIG. 5 shows an example of a schematic diagram of a system for improving a language model to generate correct outputs, in accordance with one or more embodiments. The following example is for explanatory purposes only and not intended to limit the scope of one or more embodiments.

As shown, an end user (502) sends a request for an output (508A) through a user device (504). The end user (502) may be a content generator creating content for a product. For example, the content may be a targeted ad to an existing customer for a new service related to the service the existing customer is already using. An example of such content was described in FIG. 4B. In another example, the content may be a targeted ad to a new customer for a new product.

The request for the output (508A) is received by a server controller (506) that prepares an initial prompt (510). As previously described, the initial prompt (510) includes constraints for an output (508A), contextual information (514) regarding a context of the output (508A), and an initial instruction to generate the output. A language model (516) is then executed on the initial prompt (510) to generate the output (508A).

The output (508A) is validated by the server controller (506) against rules obtained from an external knowledge base (518). As previously described, the rules may be retrieved by a RAG model. When the output (508A) is not validated because the output (508A) does not satisfy at least one rule, an updated prompt (512) is generated by the server controller (506). As previously described, the updated prompt (512) includes at least the output (508A), the at least one rule, and instructions to generate the corrected output (508B) based on the at least one rule and the output (508A).

The corrected output (508B) is then used as training data to retrain the language model (516) to generate an improved language model. The improved language model may be more successful in generating an output that can be validated and satisfy all rules without modification. The corrected output (508B) is also sent, by a content management service (520), to sources (524) for approval. The sources (524) may be, for example, a marketing team (526), a campaign manager (528), a sales team (532), and/or a legal team (530). The sources (524) may further modify the corrected output (508B) based on one or more regulations or rules as defined by each source (524).

The corrected output (508B) or the corrected output (508B) as modified by the sources (524) may be validated against the rules. In instances where the corrected output (508B) or the corrected output (508B) as modified by the sources (524) are validated, the corrected output (508B) or the corrected output (508B) as modified by the sources (524) may be further modified when not validated. In instances where the corrected output (508B) or the corrected output (508B) as modified by the sources (524) are validated, the corrected output (508B) or the corrected output (508B) as modified by the sources (524) may then be presented to the end user (502) and/or stored in a data repository (522). In some embodiments, the corrected output (508B) or the corrected output (508B) as modified by the sources (524) may not be validated and may simply be sent to the end user (502) that requested the output.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving an output from a language model executed on an initial prompt;
validating the output by comparing the output to one or more rules;
determining that the output fails to validate based on the one or more rules;
generating, in response to the output failing to validate, an updated prompt,
wherein the updated prompt includes the output, at least one rule of the one or more rules that caused the output to fail to validate, and an instruction to correct the output based on the at least one rule;
executing, a second time, the language model on the updated prompt to generate a corrected output;
validating the corrected output by comparing the corrected output to the one or more rules;
determining that the corrected output is valid based on the one or more rules; and
retraining the language model on training data to yield a retrained language model,
wherein the training data comprises at least the one or more rules, the output, the updated prompt, and the corrected output.

2. The method of claim 1, further comprising, before receiving the output from the language model:
executing, a first time, the language model on the initial prompt to generate the output,
wherein the initial prompt includes one or more constraints, contextual information regarding a context of the output, and an initial instruction to generate the output based on the one or more constraints and the contextual information.

3. The method of claim 2, further comprising:
retrieving the one or more rules from a knowledge repository external to the language model.

4. The method of claim 3, wherein the one or more rules are retrieved from the knowledge repository by executing a retrieval-augmented generation (RAG) model to retrieve the one or more rules based on the contextual information.

5. The method of claim 4, wherein the knowledge repository is generated by converting a plurality of rules into a plurality of vectors, and wherein execution of the RAG model:
receives an input to retrieve the one or more rules based on the contextual information,
converts the input into an input vector,
identifies at least one vector of the plurality of vectors that matches the input vector,
retrieves the at least one vector, and
converts the at least one vector into the one or more rules.

6. The method of claim 1, wherein the output includes at least one of text, one or more images, and one or more videos.

7. The method of claim 1, wherein the one or more rules include one or more deterministic rules and one or more non-deterministic rules.

8. The method of claim 1, further comprising, after determining the corrected output is valid:
presenting the corrected output for approval by one or more sources.

9. The method of claim 8, further comprising after presenting the corrected output for approval:
modifying the corrected output when the corrected output is not approved by at least one source of the one or more sources,
wherein the corrected output is modified based on one or more instructions provided by the at least one source of the one or more sources.

10. The method of claim 9, further comprising, after presenting the corrected output for approval:
presenting the corrected output to an end user when the corrected output is approved by the one or more sources.

11. A system comprising:
a computer processor;
a data repository in communication with the computer processor, wherein the data repository stores:
an output,
an initial prompt,
an updated prompt,
one or more rules,
an instruction,
a corrected output,
training data, and
one or more constraints,
a language model which, when executed for a first time on the initial prompt, outputs the output and which, when executed for a second time by the computer processor on the updated prompt, outputs the corrected output;
a retrained language model;
a training controller, wherein the training controller, when executed by the computer processor, retrains the languages model on the training data to yield a retrained language model; and
a server controller which, when executed by the computer processor:
validates the output by comparing the output to the one or more rules;
determines that the output fails to validate based on the one or more rules;
generates, in response to the output failing to validate, an updated prompt; and
validates the corrected output by comparing the corrected output to the one or more rules.

12. The system of claim 11, wherein the initial prompt includes one or more constraints, contextual information regarding a context of the output, and an initial instruction to generate the output based on the one or more constraints and the contextual information.

13. The system of claim 12, wherein prior to the computer processor executing the language model for the second time, the computer processor executes an additional process comprising:
executing the server controller to retrieve the one or more rules from a knowledge repository external to the language model.

14. The system of claim 13, wherein the one or more rules is retrieved from the knowledge repository by executing a retrieval-augmented generation (RAG) model to retrieve the one or more rules based on the contextual information.

15. The system of claim 14, wherein the knowledge repository is generated by converting a plurality of rules into a plurality of vectors, and wherein execution of the RAG model:
receives an input to retrieve the one or more rules based on the contextual information;
converts the input into an input vector;
identifies at least one vector of the plurality of vectors that matches the input vector;
retrieves the at least one vector; and
converts the at least one vector into the one or more rules.

16. The system of claim 11, wherein the one or more rules include one or more deterministic rules and one or more non-deterministic rules.

17. The system of claim 11, wherein after the computer processor executes the server controller to determine that the corrected output is valid, the computer processor executes an additional process comprising:
presenting the corrected output for approval by one or more sources.

18. The system of claim 17, wherein after the computer processor executes the server controller to present the corrected output for approval, the computer processor executes an additional process comprising:
modifying the corrected output when the corrected output is not approved by at least one source of the one or more sources,
wherein the corrected output is modified based on one or more instructions provided by the at least one source of the one or more sources.

19. The system of claim 18, wherein after the computer processor executes the server controller to present the corrected output for approval, the computer processor executes an additional process comprising:
presenting the corrected output to an end user when the corrected output is approved by the one or more sources.

20. A method comprising:
executing a language model on an initial prompt to generate an output,
wherein the initial prompt includes one or more constraints and an initial instruction to generate the output based on the one or more constraints;
retrieving one or more rules from an external knowledge base;
validating the output by comparing the output to the one or more rules;
determining that the output fails to validate based on the one or more rules;
generating, in response to the output failing to validate, an updated prompt,
wherein the updated prompt includes the output, at least one rule of the one or more rules that caused the output to fail to validate, and an instruction to correct the output based on the at least one rule;
executing, a second time, the language model on the updated prompt to generate a corrected output;
validating the corrected output by comparing the corrected output to the one or more rules;
determining that the corrected output is valid based on the one or more rules;
retraining the language model on training data to yield a retrained language model,
wherein the training data comprising at least the one or more rules, the output, the updated prompt, and the corrected output;
presenting the corrected output for approval by one or more sources;
determining that the corrected output is not approved by at least one source of the one or more sources;
modifying, in response to determining that the corrected output is not approve, the corrected output based on one or more instructions provided by the at least one source of the one or more sources; and
retraining the retrained language model on updated training data to yield a fine-tuned language model, wherein the updated training data comprises the training data plus the corrected output.
